(19) United States
(12) Patent Application Publication
(10) Pub. No.: US 2019/0098968 A1
(43) Pub. Date: Apr. 4, 2019

(54) MAGNETIC NECKLACE MOUNTING SYSTEM FOR CAMERAS AND MOBILE DEVICES

(71) Applicants: Alexander David Quintero, Trabuco Canyon, CA (US); David Arnul Quintero, Trabuco Canyon, CA (US)

(72) Inventors: Alexander David Quintero, Trabuco Canyon, CA (US); David Arnul Quintero, Trabuco Canyon, CA (US)

(21) Appl. No.: 15/722,753

(22) Filed: Oct. 2, 2017

(51) Int. Cl. A44C 15/00; A44C 25/00; F16M 13/04; A45F 5/00; F16B 1/00; H04M 1/05; G03B 17/56

(52) U.S. Cl. CPC A44C 15/003; A44C 25/001; A44C 15/005; F16M 13/04; A45F 5/00; F16B 1/00; F16B 2001/0035; G03B 17/561; A45F 2005/002; A45F 2200/0533; A45F 2200/0525; A45F 2200/0516; A45F 2005/006; H04M 1/05

(57) ABSTRACT

A magnetic necklace mount for a camera or mobile device is described. A magnetic necklace pendant for a camera or mobile device that allows the user the ability to attach, break-a-way and re-attach the device magnetically. The magnetic necklace holder includes a pendant of any shape with a cavity formed from an inject-able material which houses a magnet. The magnetic pendant attaches to the device by an accompanying plate that is of ferromagnetic material that includes a double sided adhesive pad that is attached to the camera or mobile device.

### FIELD OF THE INVENTION

The invention generally relates to cameras and mobile devices, particularly to holding and securing such devices to a magnetic necklace mounting system with the use of high strength neodymium magnets.

### BACKGROUND OF THE INVENTION

The prevalence of carrying mobile devices and portable cameras has become a part of everyday life for many users. Usually they are carried in a user's pocket or bag, in which to use the device it must be taken out. Having the device in such areas is not the most convenient way to carry such a device. Furthermore, repeatedly taking out a mobile device or camera can cause scratch damage to the glass or plastic display by debris that maybe inside those areas.

Additionally, with the popularity of mobile devices and cameras has come the advent of video sharing through social media websites that allow anyone to post video content. This has encouraged users to carry these devices on them daily to capture video and share their experiences. Traditionally, to take video, a user would have to either use their hands to hold the device and record video, attach the device to a stationary mount, or put a mobile device or camera on a body mount. In the first instance the user must use their hands to hold the device to record video, not allowing for hands free recording. In the second instance the user must carry a stationary mount with them, not allowing for ease of mobility. In the third instance the user must put on and wear a cumbersome body mount. In all cases there are present disadvantages that allow for ease of use.

An unobtrusive magnetic necklace mounting system allows the user to easily put on and take off the necklace, thereby encouraging the user to wear it on a daily basis. Furthermore, the use of high strength neodymium magnets allows the user to easily attach, break-a-way and re-attach the device to any magnetic surface, while maintaining a secure connection to the device, allowing for ease of use and access.

The magnetic necklace mounting system provides the advantages of holding the phone out of the way of debris in a pocket or bag, hands free video recording, ease of wearing, ease of mounting to magnetic surfaces. What is needed is a camera mounting system that addresses the limitations mentioned above.

### SUMMARY OF INVENTION

The present invention relates to a system and method for a quick, convenient, and removable way to mount and/or record video hands free using a mobile, camera, or video device, such system and method including a magnetic necklace mounting system. The system and method also includes a plate attached to the device that allows the device to be detachable from the necklace mounting system. Through the present invention, users will be able to always have their device “at the ready” to take pictures, notes, or video without having to remove the device from a pocket, bag, or hand-carry the device.

The present invention also teaches a system and method for taking photos, and/or video hands-free through the use of a magnetic necklace whereby a device is removably attached to the necklace via a plate attached to the device.

### BRIEF DESCRIPTION OF DRAWINGS

It should be expressly understood that the drawings are included for illustrative purposes and do not represent the full scope of the present invention. In the accompanying drawings, the references in different drawing may designate similar elements.

FIG. 1(a and b) illustrates two ornamental designs of the pendant.

FIG. 2 is a cross-section of FIGS. 1a and 1b, which illustrates how the magnet is affixed to the housing with glue.

FIG. 3 (a and b) illustrates how the necklace is attached to the pendant.

FIG. 4 (a and b) illustrates two ornamental designs of the accompanying plate of ferromagnetic material to connect the pendant magnet to the device.

FIG. 5 illustrates the cross section of the ferromagnetic plate with a double sided adhesive pad on one side.

FIG. 6 illustrates how the ferromagnetic plate with a double sided adhesive pad attaches to the devices.

FIG. 7 illustrates the use of the magnetic attraction to connect the magnet pendant to the device with the ferromagnetic plate.

FIG. 8 (a and b) illustrates the magnetic pendant attached to a mobile device and camera.

FIG. 9 (a and b) illustrates how the magnetic pendant necklace is worn around the user's neck.

### DETAILED DESCRIPTION

Throughout the description and pertaining to the present invention, the terms

“magnetic” or “magnet” shall refer to a material or the act of a material producing a magnetic field;

“necklace” shall refer to an article that is worn around the neck, either for decorative or utility purposes;

“device” shall refer to an electronic tool capable of performing a digital action, such as, but not limited to, recording audio, video, photos, capable of communicating over a network, capable of providing audio instructions, and the like.

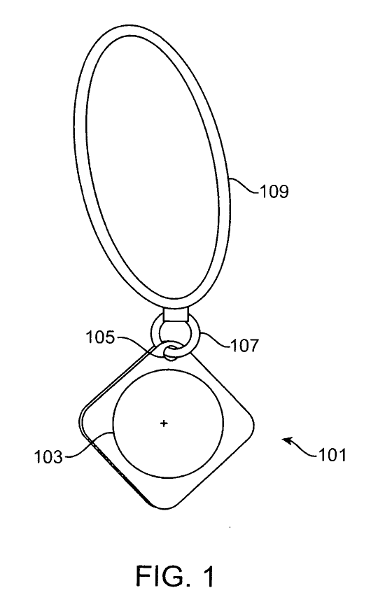

Now to FIGS. 1-9,

FIG. 1 shows the system of the present invention, including a first design pendant 105, a magnet 103 positioned thereon, an attachment hole 105 at the top of pendant 101, an attachment means 107 for attaching the housing 101 to a necklace 109, and a necklace 109.

In one embodiment of the invention, the housing 201 may be made of a variety of materials, including plastic (polymer), wood, semi-precious material (aluminum), or precious metals, for example gold or silver. As shown in previous embodiments, the housing may be any of a number of different shapes or designs.

In another embodiment, the housing 101 can be colorful or artistic in design, thus allowing the system, when the device is not connected thereto, to be used as a jewelry piece. The use of the system as a jewelry piece is logical as tech wearables are becoming a major part of the clothing industry.

The magnet 103 used in the present invention is positioned in conjunction with the pendant 111. In a preferred embodiment, the magnet 103 may be positioned centrally within the pendant 101, thus making the magnet 103, as its exposed outer side (i.e., the side facing outward from the user), flush with the outer edge of pendant 101.

In yet another embodiment, the magnet 103 is extended past the outer edge of the pendant 101.

The magnet 103 may be preferably selected from one of a rare-earth magnet, including but not limited to alloy of neodymium, iron, and boron, Nd₂Fe₁₄B, SmCos, or Sm(Co, Fe, Cu, Zr)₇. The magnet 103 may also be selected from the group consisting of iron alloy of aluminum, nickel, and cobalt, and ferrite compounds.

In a preferred embodiment, the magnet 103 is a rare-earth metal of an alloy of neodymium, iron, and boron. More preferably, the magnet 103 is Nd₂Fe₁₄B.

The necklace 109 in the present invention can be made of a variety of materials depending on the desired look on the overall system, including but not limited to ropes, choker-type style, lanyard style, and the like.

The necklace 109 is used for securing the pendant, to which a device may be attached, to the body of the user, specifically about the neck.

In one embodiment, the necklace may be interchangeable with other necklaces. For example, if the user desires a particular look to match an outfit, a user may be able to disconnect the attachment means 107 via a clasp, and remove one necklace in favor of another.

As different users have different neck sizes, the necklace may have any number of different sizes in terms of diameter to match a user's neck size. In one embodiment (though not shown), the necklace is adjustable.

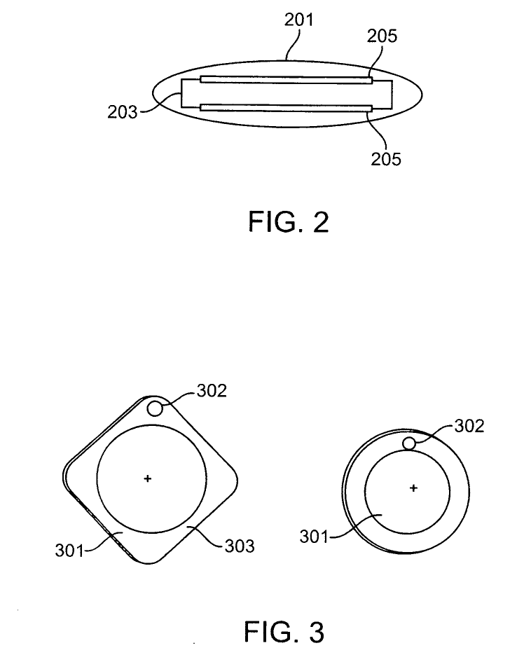

FIG. 2 is a cross-section of the pendant, showing an embodiment wherein the housing of the pendant 201 illustrates a progressively tiered slope from the high point in the middle of the pendant 201 having the magnet 203, wherein the magnet is kept in place by an adhesive material 205, for example glue.

FIG. 3(a and b) show two embodiments of the pendant 301 of the present invention. Other embodiments of the pendant can take the shape of squares, rectangles, triangles, or abstract shapes. The diameter of the pendant 301 can be of varying shapes. The pendant 301 includes a magnet 303, as previously discussed. Preferably, the magnet 303 is centered in the pendant 301 to allow even distribution of the weight of the device (not shown) when attached to the pendant 301.

The dimensions of the pendant may vary, however it is limited by the matching plate on the device (to be discussed later).

The pendant 301 also includes a hole 302 wherein the hook, allowing attachment to the necklace (also not shown).

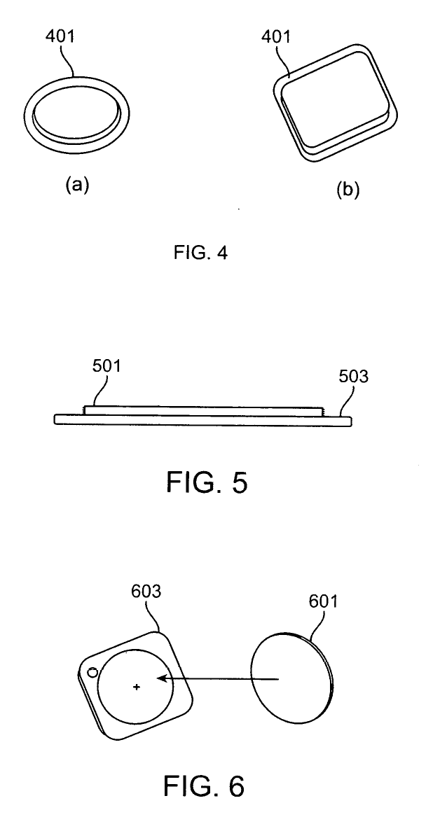

FIG. 4(a and b) show attachment plate 401. The attachment plates 401 are used to detachably connect the pendant (previously discussed) with the device. The attachment plates (8) are connected to the device, as will be discussed later.

The attachment plate 401 may be of varying size and shape, based on the needs of the device in terms of device shape, device weight, etc. The plate 401 may be made of a ferromagnetic material, such as cobalt, iron, Fe₂O₃, FeO Fe₂O₃, Ni Fe₂O₃, CuO Fe₂O₃, Mg Fe₂O₃, MnBi, Ni, MnSb, MnO Fe₂O₃, Y₃Fe₅O₁₂, CrO₂, MnAs, Gd, Tb, Dy, EuO. A and b of FIG. 4 show different embodiments of the plate shape.

FIG. 5 teaches the adhesive means 501 for connecting the plate (8) to the device (not shown). The adhesive means 501 can consist of a double-sided adhesive pad, with one side of the adhesive pad attaching to the device, and the other side of the adhesive pad attaching to the plate 503.

In one embodiment, the adhesive pad 503 is a hook and loop attachment, such as Velcro.

FIG. 6 teaches an embodiment of the present invention, wherein the plate 601 is magnetically drawn to the pendant 603, thus allowing a secure connection. In the present invention, the plate would be connected to a device, and the pendant would be attached to a necklace positioned around the neck of a user.

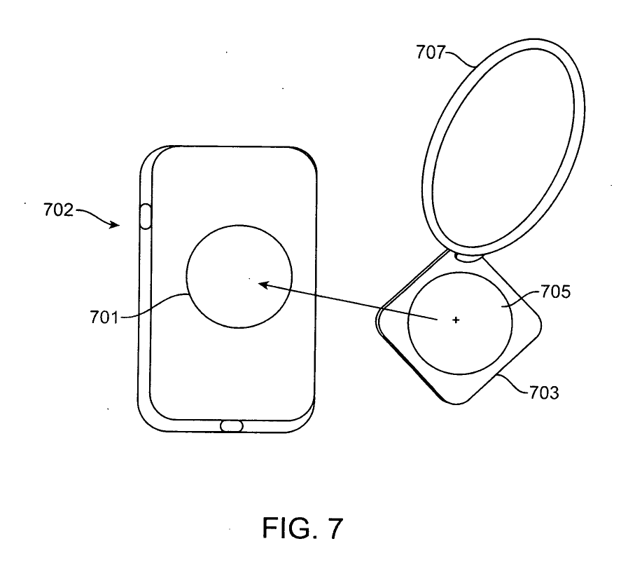

FIG. 7 further shows the present invention, wherein the plate 701 attached to a device 702 is magnetically attached to the pendant 703 specifically to the magnet 705 positioned on the pendant 703. The pendant 703 is attached to the necklace 707.

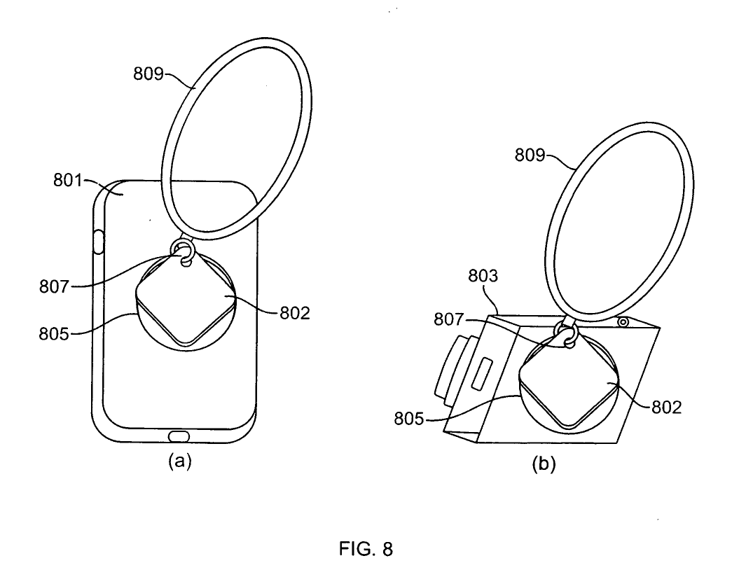

FIG. 8 (a and b) are embodiments of the design pendant 802 attached to devices, in this case a mobile phone device 801 and digital camera 803. In these embodiments, the pendant 802 is attached at the back of the devices 801 and 803 via magnetic attachment means 805. By the attachment means 807, a necklace 809 is used for securing around a user's neck.

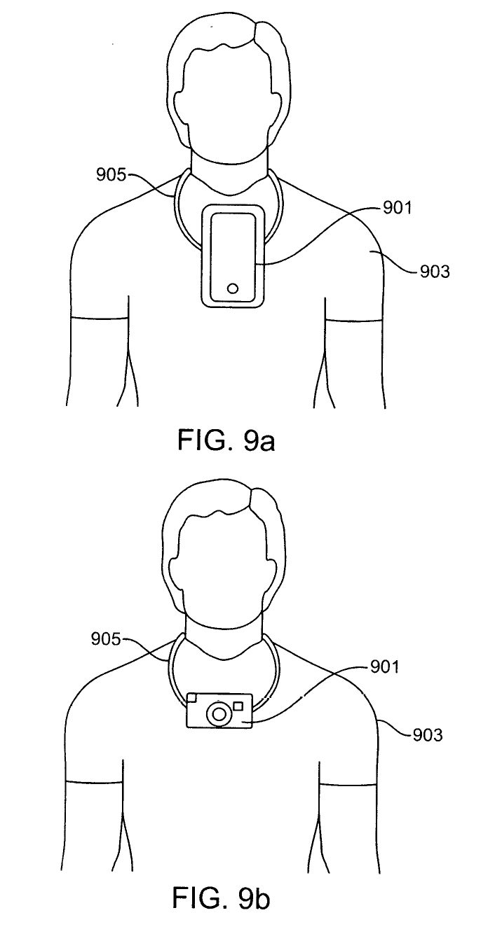

FIG. 9 (a and b) show two embodiments of the present invention, where in FIG. 9, the device is a mobile phone device connected to the pendant via the plate through a magnetic attraction. FIG. 9b shows the device being attached as a camera or video camcorder.

We claim:

1. A device for securing a handheld device on a user, comprising:
a housing;
wherein the housing includes a pendant, a magnet positioned on said pendant, an attachment hole within said pendant, and an attachment means for attaching said housing to a necklace; and further,
whereby the necklace is designed to encircle a user's neck.

2. The device for securing a handheld device in claim 1, wherein said housing is made of a material or composite material selected from the group consisting of plastic, wood, aluminum, gold, and silver.

3. The device for securing a handheld device in claim 1, wherein said magnet is made of one or more materials selected from the group consisting of iron alloy of aluminum, nickel, cobalt, and ferrite compounds.

4. The device for securing a handheld device in claim 3, wherein said magnet is Nd₂Fe₁₄B.

5. The device for securing a handheld device in claim 1, wherein said necklace is selected from ropes, choker-type style, and lanyard-style necklaces.

6. The device for securing a handheld device in claim 1, wherein the pendant is shaped as a square, rectangle, triangle or abstract shape.

7. The device for securing a handheld device in claim 1, wherein said handheld device is a camera or mobile phone.

8. A method for securing a handheld device on a user, comprising the steps of:
attaching a plate to a handheld device;
attaching a magnet to said plate, wherein said magnet is attached to a pendant, wherein said pendant has an attachment means;
attaching said pendant via said attachment means to a necklace; and
positioning said necklace around the neck of a user.

9. The method for securing a handheld device on a user of claim 8, whereby said plate is attached to said handheld device by adhering the plate to the device using double-sided adhesive pad.

10. The method for securing a handheld device on a user of claim 8, whereby attaching said magnet to said plate occurs via magnetically attaching said magnet to said plate.

11. The method for securing a handheld device on a user of claim 8, whereby attaching said pendant to said necklace occurs by inserting a clasp of said necklace into the circular attachment means of said pendant.

12. A device for securing a mobile phone on a user, comprising:
a housing;
wherein the housing includes a pendant, a magnet positioned on said pendant, an attachment hole within said pendant, and an attachment means for attaching said housing to a necklace; and further,
whereby the necklace is designed to encircle a user's neck.

13. The device for securing a handheld device in claim 1, wherein said housing is made of a material or composite material selected from the group consisting of plastic, wood, aluminum, gold, and silver.

14. The device for securing a handheld device in claim 1, wherein said magnet is made of one or more materials selected from the group consisting of iron alloy of aluminum, nickel, cobalt, and ferrite compounds.

15. The device for securing a handheld device in claim 3, wherein said magnet is Nd₂Fe₁₄B.

16. The device for securing a handheld device in claim 1, wherein said necklace is selected from ropes, choker-type style, and lanyard-style necklaces.

17. The device for securing a handheld device in claim 1, wherein the pendant is shaped as a square, rectangle, triangle or abstract shape.
